(19) United States
(12) Patent Application Publication
(10) Pub. No.: US 2026/0181744 A1
(43) Pub. Date: Jun. 25, 2026

(54) ELECTRIC HEATING DEVICE FOR A VEHICLE

(71) Applicant: Webasto SE, Stockdorf (DE)

(72) Inventors: Lutz Schade, Stockdorf (DE); Peter Neidenberger, Stockdorf (DE); Roman Mielke, Stockdorf (DE); Mustafa Yurt, Stockdorf (DE); Harald Bachmann, Stockdorf (DE)

(21) Appl. No.: 19/124,690

(22) PCT Filed: Aug. 28, 2023
(86) PCT No.: PCT/EP2023/073510

§ 371 Date: Apr. 25, 2025

(30) Foreign Application Priority Data
Oct. 27, 2022 (DE) 102022128488.3
Oct. 27, 2022 (DE) 102022128489.1

(51) Int. Cl. H05B 3/24; B60H 1/14; H05B 1/02; H05B 3/20; H05B 3/30

(52) U.S. Cl. CPC H05B 3/24; B60H 1/143; H05B 1/0236; H05B 3/20; H05B 3/30; H05B 2203/023

(57) ABSTRACT

An electric heating device for a vehicle, comprises a heating device housing, at least one heating element which is configured for heating operation at an operating voltage in the high-voltage range, a heat exchanger which is in thermal contact with the at least one heating element to transfer the heat generated by the heating element to a medium flowing through the heat exchanger, and a control module.

### CROSS-REFERENCE TO RELATED APPLICATIONS

This application is a 35 U.S.C. § 371 National Stage Entry of International Application No. PCT/EP2023/073510 filed Aug. 28, 2023, which claims priority from German national patent applications Nos. 10 2022 128 488.3 and 10 2022 128 489.1, filed with the German Patent and Trademark Office on Oct. 27, 2022, the disclosure of which is incorporated herein by reference in its entirety and for all purposes.

### TECHNICAL FIELD

The invention relates to a heating arrangement and a heater, preferably a high-voltage heater, for a vehicle, in particular an electric or hybrid vehicle.

### TECHNICAL BACKGROUND

Heating devices are regularly used in vehicles to heat an interior or passenger compartment or components such as batteries, etc. In electric or hybrid vehicles, electric heating devices are usually used, wherein air or water are used as heat transfer media or fluids because the use of waste heat is no longer an option due to the lack of an internal combustion engine and such fuel-based stationary or auxiliary heating systems are neither technically feasible nor economical in this case. Heat transfer media other than those mentioned are also possible

Electric heating devices can be operated particularly effectively in the high-volt range implemented in purely or hybrid electrically powered vehicles. In contrast to conventional vehicles with fuel-powered engines, in which the on-board power supply system is fed exclusively from 12-volt lead-acid batteries, electrically powered vehicles use vehicle batteries as energy storage devices, which allow operation at higher voltages and thus enable a meaningful drive in the first place due to the higher power of the consumers.

For larger consumers in vehicles with outputs of, e.g., 3 KW and more, such as start-stop functions (including recuperation), electrically operated air conditioning compressors and heaters etc., the 48-volt level has been established for some time. These levels are contrasted by the high-volt range as the on-board electrical system architecture in purely or hybrid electrically powered vehicles with considerably larger units (e.g., greater than 12 kW). In the automotive sector, on-board electrical system voltages of 250-800 V and more are common. A value of 60 V, for example, is generally regarded as the lower limit for the high-volt range (see “Spannungsklassen in der Elektromobilität”, ed.: Zentralverband Elektrotechnik-und Elektronikindustrie e.V. (ZVEI), Frankfurt, December 2013).

High-voltage heaters for the electrical heating of a media or fluid circuit via a heat exchanger are widely known for vehicles equipped with a high-voltage on-board electrical system. Electrical energy can be converted into heat with a high degree of efficiency, e.g., by heating elements configured as film resistors. The film resistors contact the heat exchanger directly or indirectly in order to transfer the generated heat to a fluid flowing through heat exchanger, which is then conducted to the location or component where the heat can be released again.

The heating elements are usually supplied with electrical power and controlled by a control device. For example, the heating elements can be operated by the control device by pulse width modulation when supplied with DC voltage in the high-volt range in order to achieve a specific heating output, particularly in the case of heating control. The corresponding switching frequencies of the power switching elements required for this can be in the kilohertz range, without limiting the generality, e.g., in the range from 1 to 250 KHz.

The combination of high voltages and sometimes high-frequency switching cycles regularly requires measures with regard to electromagnetic compatibility (EMC), especially in vehicles in which interference or interactions with other electronic equipment could occur. In addition to known circuitry measures, sufficient shielding must also be taken into account. The electronic components of the high-voltage heater are therefore usually installed in a metal housing, wherein the metal housing is regularly at the ground potential of the power supply in order to meet safety requirements. Die-cast aluminum or deep-drawn sheet steel constructions etc. can be used as materials.

However, such housings, which must also provide moisture and contamination protection for the electronic components they contain and thus a certain degree of tightness, can also have a complex structure in order to meet the various requirements. This may require a multi-part structure, particularly with regard to the limited shaping possibilities in the manufacturing processes, the required or desired cable bushings and their insulation, which generally increases the cost and manufacturing outlay of high-voltage heaters.

### SUMMARY OF THE INVENTION

It is therefore an object to provide an electric heating device for a vehicle, in particular an electric or hybrid vehicle, which takes into account the complexity with regard to the requirements for the housing structure and at the same time reduces the disadvantages in terms of cost and effort.

According to one aspect, an electric heating device for a vehicle, in particular an electric or hybrid vehicle, is proposed, which comprises a heating device housing, at least one heating element configured for heating operation at an operating voltage in the high-volt range, a heat exchanger which is in thermal operative connection with the at least one heating element in order to transfer the heat generated by the heating element to a medium flowing through the heat exchanger; and a control module which has a control device which is configured to supply the at least one heating element with the operating voltage in the high-volt range and to control the heating operation of the at least one heating element. The control module has a first module housing which is part of the heating device housing and is formed from a plastic and accommodates the control device.

A vehicle is generally understood to mean all possible mobile applications, in particular passenger cars, trucks, construction machinery, aircraft and watercraft. This also includes, for example, construction machinery or cranes as well as trailers such as caravans that can be towed and transported by other vehicles.

A basic idea of this aspect is to provide at least a part of the electric heating device designed as a high-voltage heating device comprising the control device with a housing made of plastic. Within the breadth of the general idea of the invention, the first module housing can also be a comprehensive component of the heating device housing and include further components such as the heating element and/or the heat exchanger. Special embodiments, which are described below, provide for the first module housing configured as a module housing which is separate from a further (second) module housing of the heat exchanger and/or heating element, but which is firmly connected to the further module housing as a component of the heating device housing, wherein the two module housings form the heating device housing together as components.

As the first module housing is made of plastic, more complex shapes for the module housing can be realized with little effort. Injection molding processes open up far greater degrees of freedom in terms of geometric design than the processes available for metalworking. Furthermore, the manufacturing costs are lower, especially in terms of material costs. In addition, the durability or reusability of casting tools, for example, is significantly greater in the case of plastics injection molding than in the case of aluminum die casting, so that a cost reduction is also achieved here.

As far as electromagnetic compatibility is concerned, it has been found that the corresponding requirements can be met by taking into account electrically conductive materials that are embedded in the plastic and can thus provide sufficient electromagnetic shielding. According to special embodiments, these can be metal inserts on the one hand and/or electrically conductive fibers, in particular carbon fibers, on the other hand, which is described in more detail below.

The use of plastic—in particular its property of allowing the creation of electrically conductive areas and electrically insulating areas in the same molding process—increases flexibility in the design of the first module housing and also enables the local electrically insulated passage of live cables, preferably in the low-voltage range, so that additional seals and precisely fitting plug inserts can be dispensed with in such a case.

The control device may have or be implemented by a printed circuit board on which one or more microcontrollers and other electronic components are arranged. The one or more microcontrollers can, for example, enable communication with an on-board power supply unit (BCM) or with an electronic control unit (ECU). Corresponding line connections can be realized on the circuit board. Furthermore, connection points for a connection to an external energy source (vehicle battery) can be implemented. In addition, the one or more microcontrollers can execute the control of power switching elements (e.g., power MOSFETs or IGBTs), which can also be placed on this or a further printed circuit board, etc. In the case of a further printed circuit board, this can be arranged separately from the control device as a power switching component in the vicinity of the heating elements and optionally outside the first module housing.

The control device may be configured to carry out heating control. One or more temperature sensors can be placed on the heat exchanger or at least in its vicinity and electrically connected to the control device in order to detect fluid temperatures and forward corresponding signals to the control device. The control device or a microcontroller thereof can compare the temperature or values derived from it with a threshold or target value and, depending on the result, adjust the heating power in order to set a desired target temperature in the fluid, e.g., at the fluid outlet.

To control the heating power, the control device can operate the power switching elements by means of pulse width modulation. The operating voltage in the high-volt range is preferably a DC voltage for this purpose.

It should be noted that the electric heating device according to the aspects and embodiments described herein may in particular be a liquid heating device. A liquid heating device means that the medium flowing through the heat exchanger of the heating device is liquid. In particular, the medium can be liquid coolant of a vehicle, which transports heat in the vehicle and can release it at various points. Additionally or alternatively, the liquid heating device can also be a component of a vehicle heat pump, for example, so that the heat transfer medium can be or comprise a refrigerant of a heat pump, for example. It may be that the refrigerant is only present in completely liquid form under certain conditions and only temporarily or perhaps never, and is otherwise also partially or completely gaseous. Nevertheless, this is also understood to mean a liquid heating device.

The liquid heating device can preferably have a heat output of at least 5 KW, preferably at least 7 kW, for example at least 9 kW. The heating output is preferably less than or equal to 13 KW in each case.

The operating voltage with which the vehicle heating device (or the heating element(s)) is operated, which can be equal to the on-board or supply voltage of an electrically powered vehicle, can be greater than or equal to 60 V, preferably 400 V, more preferably greater than or equal to 700 V, for example 800 V, 900 V or 1000 V.

The liquid heating device has at least one heating element. The control device can also operate several of the heating elements independently of each other or in parallel. The heating element or elements can have a heating conductor layer that acts as a film resistor. Preferably, the liquid heating device has at least two heating elements, particularly preferably at least three heating elements.

A heating conductor layer can preferably have corresponding heating conductor tracks. The heating conductor layers and heating conductor tracks can be arranged together on a single carrier element. Preferably, each heating conductor layer or each heating conductor track is applied to its own separate carrier element. The carrier element can also be a wall or plate of the heat exchanger, so that the heat exchanger and heating element can share individual elements.

The heating element or the heating conductor layer can be implemented in various ways and the invention is not limited to specific embodiments thereof. For example, the heating element may consist of thermally sprayed layers. During manufacture, atmospheric plasma spraying can be used as a coating process, for example. It is also possible to apply heating elements on both sides, i.e., also on a cover wall and a base wall of the heat exchanger. Starting from a flat plate, which is formed by a cover or base wall of the heat exchanger, the layer structure is initially an optional adhesive base, followed by an insulating ceramic, the actual heating conductor layer and, if necessary, a top layer or sealant. The heating conductor layer can be structured by laser or by means of masking. The material of the heating conductor can be one with linear or PTC resistance behavior.

Polymer-based heating elements with PTC behavior may also be considered. These can be heating elements made from plastics films. The heating elements usually consist of an extruded or laminated polymer matrix in which a heating conductor and a positive and negative electrode are embedded.

Furthermore, the heating elements may also be ceramic heating elements with PTC behavior (PTC thermistors).

In addition, the heating element can be designed as a thick-film heating element. In this case, the carrier element may again be a plate of the heat exchanger. The thick-film heating element, which can be a dielectric and a heating conductor to represent a planar heating resistance, is applied to this plate.

The heating element may also be designed as a ceramic substrate (as a carrier element), for example made of Al₂O₃, with a screen-printed heating conductor layer. The heating conductor layer can, for example, be designed as a metallization made of a resistance alloy, which represents the corresponding heating resistance. Among others, an iron-nickel alloy or a nickel-chromium alloy can be considered. An insulating interruption ensures the structuring of long conductor paths from the otherwise flat applied and later baked layer and can, for example, already be produced during application by means of a screen printing process. The ceramic substrate can be a ceramic support plate. According to aspects of the invention, this embodiment of a heating element is preferred.

In the case of the described polymer-based heating element with PTC behavior, the ceramic heating element with PTC behavior or the heating element as a ceramic substrate with screen-printed heating conductor layer, the flat heating element can be applied to an outer side of the cover or base wall, which is usually configured as a flat plate, by means of a thermal intermediary as an adhesive layer, e.g., thermally conductive adhesive. However, the thermal intermediary can also be used in combination with a pressing device.

It should be noted that, according to embodiments of the invention, heating elements can also be applied to both sides of the heat exchanger, i.e., to the cover wall and to the base wall.

The heat exchanger itself can, for example, be made of steel or aluminum, preferably also as a sheet metal heat exchanger. According to special embodiments, the boundary walls forming a flat fluid chamber of the heat exchanger comprise a cover wall, a base wall opposite the cover wall and narrow side walls connecting these, which are formed, for example, by trough-like deep drawing of the cover or base wall, wherein a fluid inlet and a fluid outlet are formed, for example, in the base wall. The cover wall and the base wall are preferably flat and extend substantially along a plane defined by the heat exchanger.

The described, purely exemplary but advantageous design of the heat exchanger means that an installation height perpendicular to the cover wall, to which the heating element can be attached or which the heating element also forms, is significantly less than a width and length with which it extends parallel to the cover wall.

According to exemplary embodiments, the heat exchanger may preferably be designed in two parts. It can have a base part and a cover part which, together with a turbulator inserted therein, are connected to each other in an integrally bonded and possibly also form-fitting and/or frictionally engaged manner, in particular by soldering or welding. The base wall can be part of the base part together with the side walls and the cover wall can be part of a cover part preferably designed as a flat plate. The cover wall and cover part may be identical.

The turbulator can have a preferably filigree structure and contain a grid structure. It is preferably in thermally conductive contact at least with the cover wall in order to conduct the heat transferred via the latter into the grid structures around which the fluid flows, so that the fluid absorbs the heat efficiently due to the large contact surface between the fluid and the grid. The turbulator can change the fluid flow in the interior to a turbulent flow so that the medium or fluid flowing through the interior is better mixed, which further increases the efficiency of the heat exchanger. The grid-like turbulator can, for example, be made from a single sheet of metal. Slots can first be punched into the sheet metal for production. A grid-like structure of the turbulator can then be created, for example by “accordion-like” folding. The turbulator can be made of the same material as the base and/or cover wall. Preferably, the turbulator is also attached to the base wall in order to prevent dynamic bulging and thus a change in the hydrodynamic conditions due to the high pressures of the fluid flowing through. As an alternative to inserting a continuous grid-like turbulator, it is also possible for the base wall and/or the cover wall to have a large number of projections which, when assembled, project into the interior and thus also form a grid-like turbulator there. Other embodiments for a heat-transferring mechanism are also possible.

According to a particular embodiment of the invention, the heat exchanger and the at least one heating element form a heat exchanger module and are accommodated by a second module housing. They form a separate unit with respect to the control module, but are structurally and electrically connected to the latter. The first module housing is a different component from the second module housing. According to the embodiments mentioned above, the second module housing can be formed by the trough-shaped base part of the heat exchanger and a housing cover attached to it or to the flat cover part of the heat exchanger for housing the heating element(s) (and optionally an associated power switching component). In particular, the second module housing can be made of sheet steel and/or die-cast aluminum, etc.

According to a particular development of the aspects and embodiments described, the first module housing has a first layer of electrically conductive plastics material. A layer is understood here to be a planar structure. In the breadth of this aspect, it is not necessary for this layer to provide an almost complete enclosure of an interior; passages and exclusively insulating wall regions are also possible, as further embodiments described below provide.

However, it has been found that the first layer of electrically conductive plastics material can achieve extensive shielding with regard to electromagnetic compatibility, especially in the high-volt range of heating operation, if this layer extends over at least large or significant parts of the module housing wall. In terms of EMC, it can therefore certainly replace the conventional metal housing in terms of its effect.

According to an exemplary embodiment, the electrically conductive plastics material is a plastic reinforced with carbon fibers. According to further embodiments, the mass fraction of carbon fibers can be between 10% and 80%, preferably between 20% and 60%, more preferably between 30% and 50%, still more preferably between 35% and 45%, ideally around 40%. In the latter case, the most satisfactory results are obtained in terms of simultaneous strength, elastic behavior, durability, injection molding properties, electrical and thermal properties.

The plastic used, in which the carbon fibers are incorporated or embedded, is preferably a temperature-resistant, heat-resistant plastic, in particular a thermoplastic, preferably PPS (polyphenylene sulfide). The carbon fibers can be any type of fiber, including HT—high tenacity, UHT—ultra-high tenacity, LM—low modulus, IM—intermediate (intermediate modulus), HM—high modulus, UM—(ultra modulus), UHM—(ultra-high modulus), UMS—(ultra modulus strength), HMS—high modulus/high strength (high modulus/high strain). The filament size and the density of filaments or fibers in the polymer matrix are selected so that, among other things, the desired electrical properties are achieved for the application in question.

A further embodiment provides for the first module housing to have a second layer of electrically insulating plastics material. Such a second layer, particularly in combination with the first layer of electrically conductive plastics material, makes it possible to simultaneously meet the EMC requirements in the high-volt range (first layer) and to create wall areas in the first module housing of the control module which, thanks to complete insulation (only the second layer is formed), allow cables to be easily fed through the housing wall (e.g., for low-voltage plugs integrated into the wall).

However, it should be particularly emphasized that, because the first layer has a significantly higher specific resistance compared to an aluminum die-cast, for example, despite its electrical conductivity, a second layer applied to the outside surface of the first layer increases the safety of persons touching the heater (for example when servicing the heater or adjacent components) from electric shocks that are hazardous to health.

According to a development of these aspects, the electrically insulating plastics material can be a plastic reinforced with glass fibers. According to further embodiments, the mass fraction of glass fibers may be between 10% and 80%, preferably between 20% and 60%, more preferably between 30% and 50%, still more preferably between 35% and 45%, ideally about 40%. In the latter case, the most satisfactory results are obtained with regard to simultaneous strength, elastic behavior, durability, injection molding properties, electrical and thermal properties, in particular also in combination with the corresponding properties of the first layer.

According to the examples described above, the first module housing can accordingly have a 2-component structure, wherein the second layer forms an exposed outer surface of the first module housing on the outside and the first layer largely surrounding an interior of the module housing on the inside relative to the second layer, wherein the first layer and second layer preferably are molded together and form a single-piece component. The first layer may optionally also form a surface defining an interior of the first module housing, but may itself also be completely or partially coated towards the interior. It should be noted that the interior may be at least partially filled with a potting or filling compound that protects the components mounted therein (moisture, mechanical damage, heat dissipation). It is important that the first layer is effectively configured for EMC shielding and, for this purpose, surrounds the interior with components mounted therein to such an extent, i.e., to a large extent, that this objective is achieved. The omission of individual openings or individual smaller insulating wall areas can be tolerable as long as the EMC shielding is not impaired. Individual examples are described below.

This does not preclude the first module housing from being formed from a base component and a cover during manufacture prior to assembly. Both parts are preferably manufactured from the components in an injection molding process and can then be joined together (after installation of further components such as in particular the control device (printed circuit board) etc.) by ultrasonic welding, gluing or another sealing joining process.

In the first module housing of the electronic heating device, according to a further exemplary embodiment, a high-voltage connector portion may be configured as a separate, subsequently mounted component, which is at least partially enclosed by a metal ring connected to a ground potential, wherein the metal ring is embedded in the first layer of electrically conductive plastics material and/or between the first layer and the second layer—at least in contact with the first layer. The metal ring may preferably be made of aluminum, copper or sheet steel.

Namely, it has been found that the density of the carbon fibers can be reduced after an edge of the mold due to the process, particularly in the case of 2-component injection molding.

An opening formed in the first module housing, which is only subsequently closed by inserting the separate connector portion, forms such an edge. However, the high-voltage connector portion forms (possibly among other things) electrical lines for the provision of a high-voltage on-board power supply or supply voltage, which preferably also requires special shielding. The metal ring can therefore further support the shielding at this point as a “neuralgic point”. By embedding it in the first layer of electrically conductive material, it is already connected to the conductive part of the housing.

The shielding is further improved if the metal ring is electrically conductively connected to a metal support plate of the heat exchanger module (preferably the flat cover wall, which, according to embodiments, protrudes laterally beyond the actual fluid chamber and thus defines an attachment portion) via a first metal conductor embedded in the electrically conductive plastics material. This also improves the ground potential connection of the first layer in which the ring and the metal line are embedded, which forms a “drainage channel”, so to speak, for electrical charge for the purpose of potential equalization. Similarly, the metal ring may additionally or alternatively be connected to an earth connection of a printed circuit board of the control device via a second metal line embedded in the electrically conductive plastics material. The effect here is analogous.

In addition, as indicated above, a low-voltage connector portion may be provided in a portion of the first module housing, wherein the first layer of the electrically conductive plastics material does not extend in the portion, so that a wall of the first module housing in the region of this portion is formed substantially only by the second layer of the electrically insulating plastics material. As described, this makes it possible to form an insulated connector portion integrated in the housing wall, which saves additional parts and components.

Furthermore, an exemplary embodiment provides that at least one aperture is formed in the first module housing for passing through an electrical connection between the control device in the first module housing and a power switching part for switching the heating element in the second module housing. In this case, a punched grid, specifically a lead frame, with conductor tracks embedded in a common plastics component can be arranged in the at least one aperture, wherein the conductor tracks contact corresponding connection points on a printed circuit board forming the control device.

The punched grids enable a robust electrical connection with the power switching elements and/or with the heating elements, and allow the sides of the heat exchanger to be changed in a space-saving manner, as the first housing module is preferably attached to the second housing module in a direction substantially perpendicular to a plane of the heat exchanger, so that the connecting pieces (fluid inlet, fluid outlet) as well as the connector portions (high-voltage, low-voltage) can be accessed from the same side in a state installed in a vehicle. However, this in turn requires the heating element(s) to be arranged on an opposite side of the flat heat exchanger. The through-openings in the support plate of the heat exchanger therefore allow direct access to the second module housing on the side of the heating element(s).

Advantageously, the punched grid and a through-opening formed in the support plate and an aperture formed in the first module housing and aligned with the through-opening can extend into an interior of the first module housing, where it is fixed to the printed circuit board forming the control device by at least one positioning means, in particular a positioning pin.

For the mutual fixing of the two module housings, fastening means, in particular one or more screws, can be provided in order to fasten a support plate of the heat exchanger module to the first module housing, wherein the support plate has the through-opening which is aligned with the at least one aperture in the first module housing, so that the punched grid extends through the through-opening of the support plate and provides contact connections for its conductor tracks on the opposite side thereof.

A seal can be installed between the facing surfaces of the first module housing and the support plate of the second module housing (of the heat exchanger), which encloses the at least one through-opening or the at least one aperture (in the case of several through-openings and associated apertures, encloses them together) and thereby protects the interior of the first module housing and an interior of the second module housing comprising the power switching part and the heating element from moisture ingress.

Further embodiments of the invention can be found in the appended dependent claims.

### BRIEF DESCRIPTION OF THE DRAWINGS

Exemplary embodiments of the invention are explained in more detail below with reference to the drawings. These show:

FIG. 1 a perspective view of an electric high-voltage heating device according to an exemplary embodiment;

FIG. 2 a plan view of an arrangement of heating elements on a support plate of a heat exchanger of the heating device shown in FIG. 1;

FIG. 3 a perspective view of the control module of the heating device from FIG. 1, with a view of the outer second layer of electrically insulating plastics material;

FIG. 4 as FIG. 3, but with the high-voltage connector portion hidden;

FIG. 5 as in FIG. 4, but with a view of the inner first layer of electrically conductive plastics material with the second layer hidden;

FIG. 6 as FIG. 5, but with the first and second layers hidden (only the base component, cover still being visible);

FIG. 7 isolated illustration of the positioning of punched grids, fastening screws, sheet metal inserts and seal;

FIG. 8 perspective view of the interior of the first module housing according to the exemplary embodiment;

FIG. 9 perspective view of the first module housing from behind, with the second layer as the outer surface;

FIG. 10 as FIG. 9, but with the second layer hidden, i.e., with a view of the inner first layer;

FIG. 11 as FIG. 8, but with all electronic components including the control device installed but with the cover removed;

FIG. 12 as FIG. 11, but with hidden control device (hidden circuit board and potting or filling material);

FIG. 13 a perspective view of the first module housing from below, without punched grid;

FIG. 14A a perspective view of one of the punched grids;

FIG. 14B a further perspective view of the punched grid from FIG. 14A.

### DETAILED DESCRIPTION OF PREFERRED EMBODIMENT(S)

In the following description of a preferred exemplary embodiment, it should be noted that the present disclosure of the various aspects is not limited to the details of the structure and arrangement of the components as shown in the following description and in the Figures. The exemplary embodiment can be put into practice or implemented in various ways. It should also be noted that the expressions and terminology used here are used solely for the purpose of the specific description and should not be interpreted as such in a restrictive manner by a person skilled in the art. Furthermore, in the following description, identical reference signs in the exemplary embodiment or the Figures designate identical or similar features or objects, so that in some cases a repeated detailed description of the same is dispensed with in order to preserve the compactness and clarity of the description.

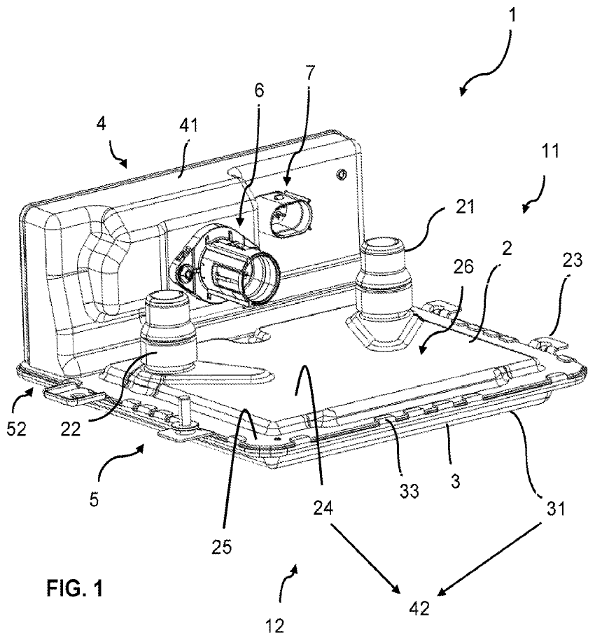

FIG. 1 shows a perspective view of an exemplary embodiment of an electric heating device 1 according to the present invention. In particular, this is a high-voltage liquid heating device for electrically powered or hybrid-powered vehicles.

The electric heating device 1 substantially comprises three components, namely a heat exchanger 2, a heat conversion unit 3 and a control module 4. The heat exchanger 2 and the heat conversion unit 3 may be structurally combined to form a heat exchanger module 5, to which the control module 4 is attached. The heat exchanger module 5 has a substantially flat structure with a rectangular outline in plan view.

In FIG. 1, the heat exchanger 2 is oriented upwards and has a deep-drawn base component 24 which, together with a flat or level cover component 25, forms an equally flat fluid chamber 26 (in FIG. 1, the base component is at the top and the cover component at the bottom). A flat circumferential edge of the base component is soldered or welded to the cover component in order to close off the fluid chamber at the side. Since the base component 24 in FIG. 1 rests on the cover component 25 (only indicated by an arrow), the cover component 25 is barely visible. A turbulator (not shown in the Figures) is inserted in the fluid chamber 26, which mixes the fluid flowing through as described and supports the heat transfer to the fluid. The fluid can flow into the fluid chamber through a fluid inlet 21 and, after heating, flow out again through the fluid outlet 22.

The heat conversion unit 3 has three heating elements 34 and a power switching component 35, which are covered by a housing cover 31, which is attached to the flat cover component 25 (or the edge of the base component 24 soldered or welded to it) by means of folded tabs 33. Laterally outwardly directed attachment elements 23, which are integral with the housing cover 31, protrude from the housing cover 31 in the plane defined by the heat exchanger 2 and allow it to be secured in a vehicle.

The cover component 25 is configured as a flat plate and is hereinafter referred to as support plate 25. Taken together, the base component 24 of the heat exchanger 2 and the housing cover 31 of the heat conversion unit 3 form a second module housing 42 for the heat transfer module 5 in the specific exemplary embodiment.

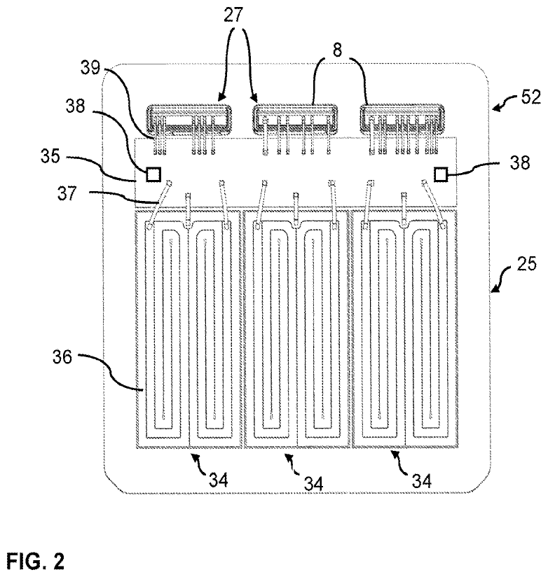

FIG. 2 shows a plan view of the heating elements 34 and the power switching component 35 in the state mounted on the support plate 25 of the heat exchanger 2. In the exemplary embodiment, the heating elements are configured as a ceramic substrate (as a support element), for example made of Al₂O₃, with a screen-printed heating conductor layer. The heating conductor layer is designed as a metallization made of a resistance alloy and provides the corresponding heating resistance. An insulating interruption ensures the structuring of long conductor paths 36. The ceramic substrate may be attached to the flat support plate 25 via a thermally conductive adhesive layer (not shown).

The heating conductor tracks 36 are configured with regard to their resistances (defined by thickness, length, width and specific film resistance of the material used) in such a way that they can generate the desired heating power at the operating voltage provided in the high-volt range, in the example 800 V, preferably in the range of 5-13 KW combined.

The power switching component 35 is configured as a printed circuit board and has a number of power switching elements not shown, for example IGBTs or power MOSFETs, with which the heating elements 34 can be operated under PWM control. For this purpose, corresponding connection pads of the heating conductor tracks 36 are connected to the power switching elements on the power switching component 35 via bond connections 37.

The power switching component 35 also has temperature sensors 38, which can detect a temperature for the purpose of controlling the heating operation. In the exemplary embodiment, their position on the power component corresponds to the fluid inlet 21 and the fluid outlet 22 on the rear of the support plate 25.

The power switching component 35 is connected via further bond connections 39 to respective connections that are formed at three punched grids 8, which are assigned to the respective heating elements 34. The bond connections 39 contain electrical lines for the power supply (high voltage), for controlling the power switching elements and for communication with the temperature sensors. The punched grids 8 are arranged in through-openings 27 of the support plate 25, which are arranged in an attachment area 52 of the support plate 25 for attaching and fixing the control module 4.

The control module 4 comprises a control device 40, a first module housing 41 accommodating the control device 40, as well as a high-voltage connector portion 6 and a low-voltage connector portion 7 arranged therein. The first module housing 41 has a roughly cuboidal structure. Portions 7 and 8 are designed here as built-in connectors into which couplings of a corresponding high-voltage and low-voltage connection on the vehicle can be plugged.

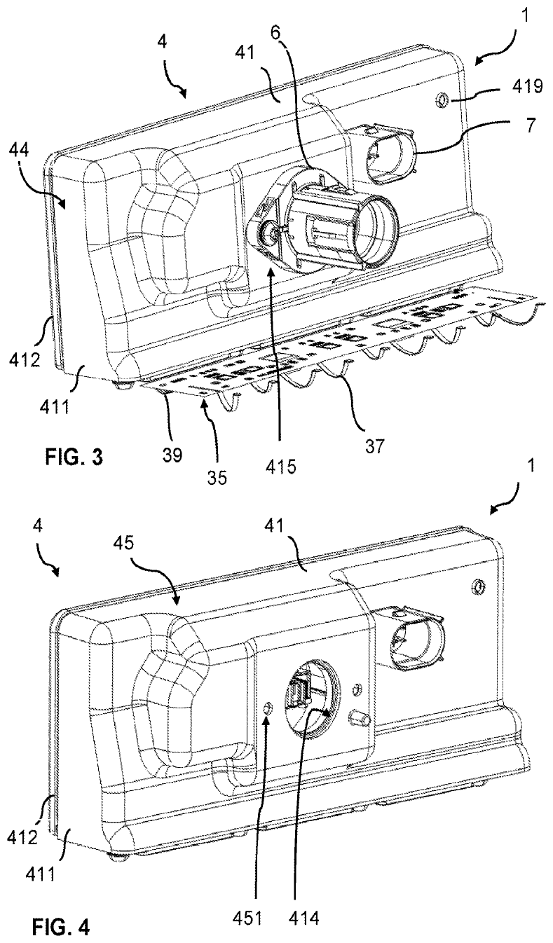

FIGS. 3 to 6 show more precise details of the structure of the control module 4, wherein elements are successively hidden in the perspective of FIG. 1 in order to allow a view into the interior of the control module 4.

In FIG. 3, only the control module 4 and the power switching component 35 connected to the control device 40 are shown. It can be seen therein that the first module housing 41 has a base component 411 with complex geometry and a substantially flat cover 412 which closes its opening (directed to the rear in FIG. 3) and is fixed thereto by ultrasonic welding. The base component 411 and cover 412 define an interior 413 (not shown in FIG. 3) in which the control device 40 is arranged. FIG. 3 also shows the bond connections 37 from the heating elements 34 (not shown in FIG. 3) to the power switching component 35 and, to some extent, the further bond connections 39 from the power switching component 35 to the punched grids 8, which in turn are connected to the control device 40.

FIG. 3 also shows a pressure equalization opening 419, which connects an external environment with the interior 413 of the first module housing 41. On the inside, a Gore-Tex membrane 491 is attached at this point (e.g., by ultrasonic welding) in order to prevent moisture from entering; see FIG. 8 (only housing with pressure equalization opening 419, without further elements) and FIG. 12 (with membrane 491).

FIG. 4 shows the same view as FIG. 3, but with the high-voltage connector portion 6 hidden. This shows an opening 414 for the high-voltage connector portion 6, which is configured as an independent component and is to be inserted therein and fixed with screws 415.

The first module housing 41 is formed to a large extent from two-component plastics material. In particular, the first module housing 41 comprises an inner first layer 44 and a second outer layer 45. In FIGS. 3 and 4, the view is directed to the outer surface of the first module housing, so that the outer second layer 45 is recognizable. The second outer layer 45 is made of electrically insulating plastic. In particular, this is a thermoplastic material reinforced with glass fibers, for example PPS. The proportion (mass) of glass fibers in the material is 40 %.

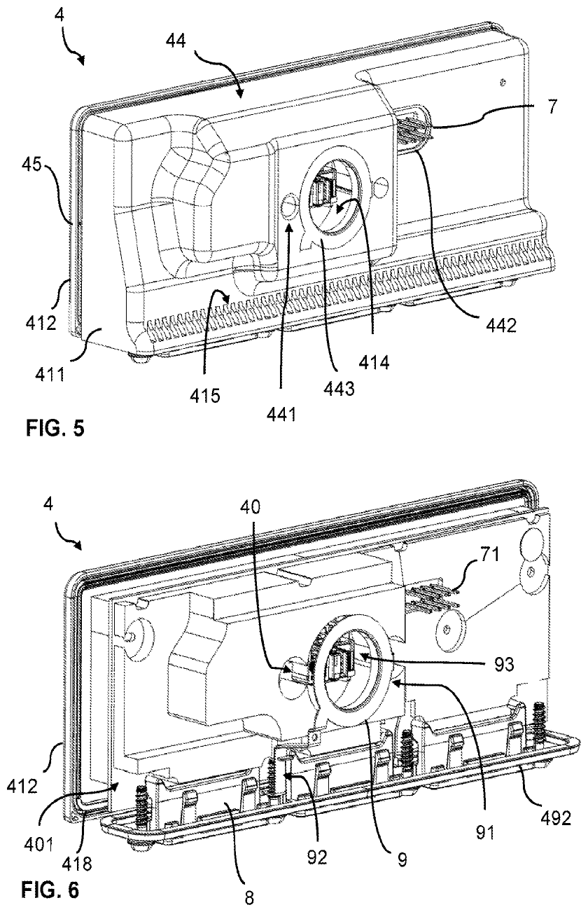

FIG. 5 shows the same perspective of the first module housing 41 as in FIG. 3 or 4, but with the second layer 45 hidden, so that the view of the inner first layer 44 made of electrically conductive plastics material is unobstructed. The plastics material is thermoplastics material reinforced with carbon fibers. The proportion (mass) of carbon fibers is 40%. The thermoplastics material here is also PPS, for example, so that both layers have similar and therefore compatible thermal properties. PPS is considered flameproof and is therefore particularly suitable for use in heating appliances.

To produce the first module housing 41, the two plastics material compositions are injection molded one immediately after the other. First, the plastics material of the first layer 44 is injection molded, and then, while the temperature is still slightly above 100 degrees, it is removed with the rotary plate and injected with the plastics material to form the second layer. The temperature ensures that good adhesion is achieved, but does not cause mutual fusion and mixing. As shown in FIG. 5, in order to further improve the mutual adhesion and thus to ensure permanent one-piece integrity, a corrugation 415 formed during injection molding can be seen in the first layer 44, which is also reflected accordingly in the second layer 45 injected onto it (not shown).

Furthermore, it can be seen in FIG. 5 that the first layer 44 does not extend in a portion 442 in which the low-voltage connector portion 7 is formed. In contrast, this is filled by the second layer 45, so that the low-voltage connector portion 7 is formed integrated in the first module housing 41 (and does not represent a component to be subsequently fixed). As can be seen in the perspective view of the interior 413 of the first module housing 41 in FIG. 12, the pins 71 of the low-voltage connector portion 7 extend directly through the second layer 45 and are thus insulated from one another.

It can also be seen in FIG. 5 that where in FIG. 4 self-tapping screws 415 for fixing the high-voltage connector portion 7 (see FIG. 3) each form a comparatively small hole 451 in the second layer 44, the first layer is also excluded; cf. the larger holes 441 in FIG. 5. This ensures that no high-voltage voltage reaches the surface via the screws 415, which cannot be dissipated quickly enough due to the material of the first layer 44.

Furthermore, a recess 443 in the first layer 44 can be seen in FIG. 5 around the opening 414 for the high-voltage connector portion 6. A metal ring 91 of a sheet metal insert 9, which is hidden in FIG. 5 but shown in FIG. 6, is embedded in this recess and serves as shielding in the area of the opening 414 when the high-voltage connector portion 6 is inserted there and heating operation is running. With the sheet metal insert integrated into the two-component plastics material, the base component 411 is at least a three-component material.

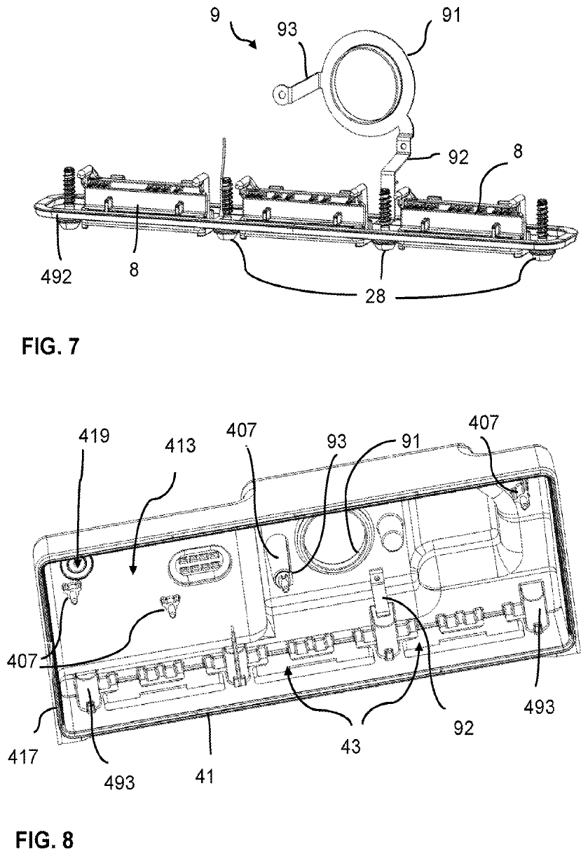

The sheet metal insert 9 also has a first metal line 92 and a second metal line 93, as can best be seen in FIG. 7, which are also at least partially embedded in the first layer 44. The first metal line 92 extends from the metal ring 91 to a connection on the support plate 25, which is formed by one of four fastening screws 28 for fixing the control module 4 to the support plate 25. The second metal line 93 extends from the metal ring 91 to a connection on the printed circuit board 401 of the control device 40. The metal ring 91 is therefore safely at ground potential. FIG. 8 shows surfaces of the sheet metal insert 9 partially exposed towards the interior 413 in the inner first layer 44.

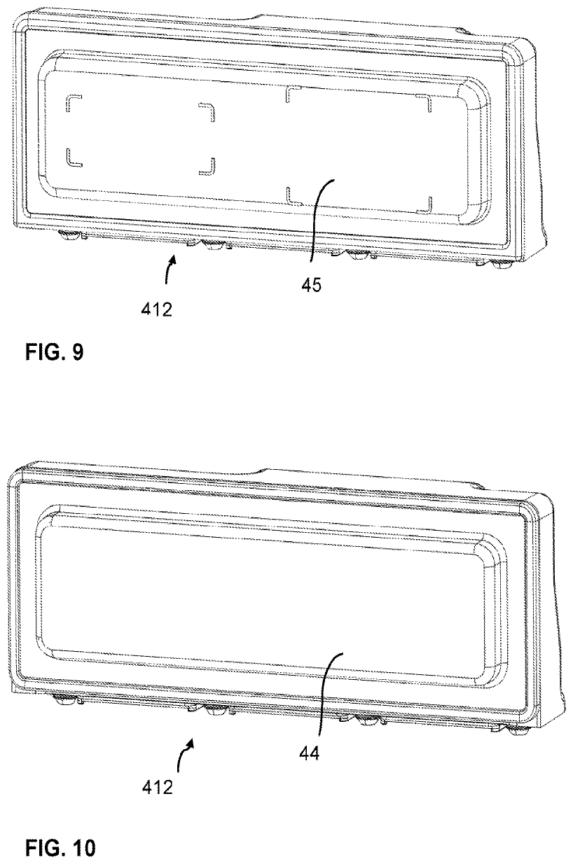

FIGS. 9 and 10 show the control module from the rear side, i.e., in particular the cover 412 of the module housing 41. In FIG. 9, the view is directed to the outer second layer, which also forms the outer surface, and in FIG. 10, the view is revealed to the inner first layer 44 (the second layer is hidden in FIG. 10).

The cover 412 is irreversibly fixed to the base component 411 by ultrasonic welding, for which purpose a groove 418 can be provided in the cover 412 (see FIG. 6), into which a circumferential lug 417 (see FIG. 8) of the base component 411 is inserted and welded.

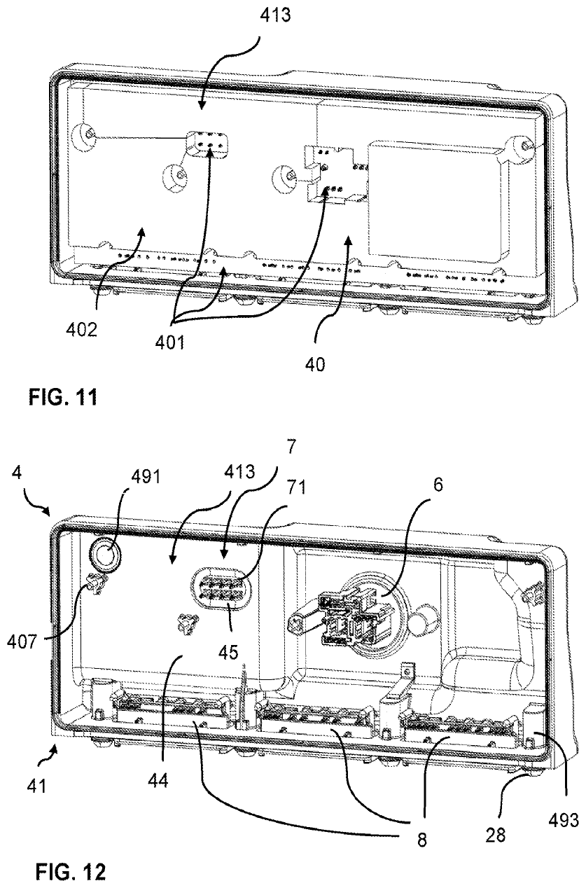

The control device 40 is best seen in FIG. 11. It is formed by a printed circuit board 401 with electronic components arranged thereon, in particular one or more microcontrollers (not shown). A potting compound 402 stabilizes and protects the control device 40 in the interior 413 of the first module housing 41. Four positioning pins 407 are shown in FIG. 8, which extend from the first housing module 41 (as an integrally formed part thereof) into the interior 413 and, when installed, extend through holes (not shown) in the printed circuit board 401 and are heat-caulked thereto, so that the printed circuit board 407 is firmly positioned and supported in the interior 413.

FIGS. 6 and 7 and in greater detail FIGS. 14A and 14B show the three punched grids 8 mentioned above. These have conductor tracks punched out of a sheet metal and embedded in a plastics component. The conductor tracks make contact with corresponding connection points on the printed circuit board 401 forming the control device 40. The relative positioning is achieved by dome-like positioning pins 85, which engage in corresponding holes formed in the printed circuit board 401 (not shown).

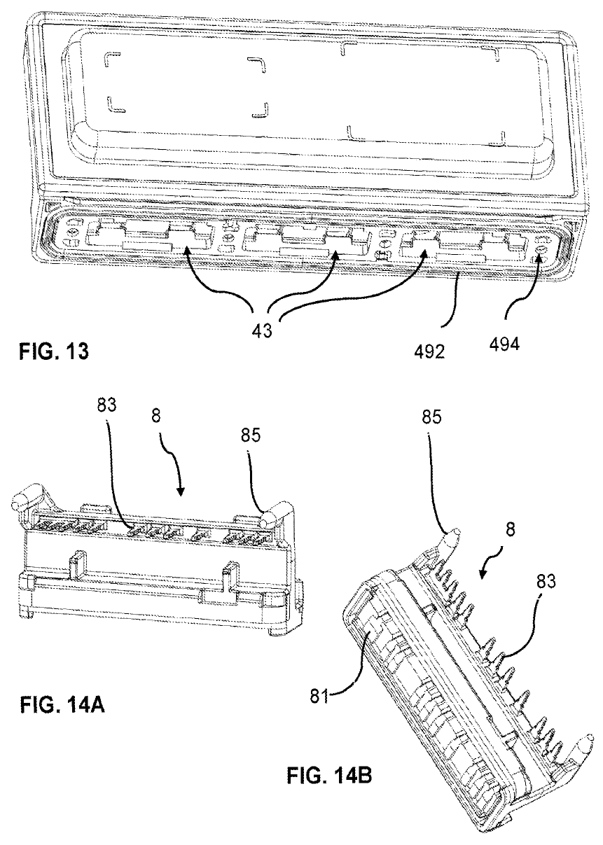

The punched grids 8 are spatially arranged in respective corresponding apertures 43, which are formed in a lower region of the first module housing 41, as can be seen in FIGS. 8 and 13. In the assembled state, the apertures 43 of the first module housing 41 and the through-openings 27 in the support plate 25 are aligned with one another, so that the punched grids 8 extend through both and are fixed in their position.

As shown in FIGS. 14A and 14B, the punched grids 8 have conductor tracks with connections at both ends. The connections 81 are used to contact the bond connections 39, with which the electrical connection to the power switching component 35 is realized. The connections 83 are pin-like and are fixed (soldered) in the assembled state using THT technology (through-hole mounting) at contact points on the printed circuit board 401, i.e., connected to the control device.

FIG. 13 shows that on the underside of the first module housing 41, in addition to the apertures 43 for the punched grids 8 in the area of four wall reinforcements 493 (cf. FIG. 12) in the first module housing 41, holes 494 of self-tapping fastening screws 28 are provided in each case, which are shown in their position relative to the module housing in FIGS. 6 and 7. A seal 492 can also be seen in FIG. 13, which encloses the at least one through-opening 27 or the aperture 43 and thereby protects the interior 413 of the first module housing 41 and an interior of the second module housing 42, which accommodates the power switching part 35 and the heating element 34, from moisture ingress. For assembly, the fastening screws 28 are inserted through corresponding holes (not shown) in the support plate 25 and screwed into the wall reinforcements 493 shown in FIG. 13. The seal is placed between the facing surfaces of the support plate 25 and the first module housing or is molded into a groove provided on the first module housing and is pressed by the fixation. In particular, the seal can advantageously be molded directly onto the base component 411 by injection molding. In this variant, the base component 411 thus concerns at least a four-component material due to the two different plastics, the sheet metal insert and the seal.

As described, the disclosure content of the national German patent application with the file number DE 10 2022 128 489.1, filed with the German Patent and Trademark Office on Oct. 27, 2022, the priority of which is claimed here, is incorporated by reference into the present description. The embodiment shown in FIGS. 1 to 7 of a heating device referred to there as a heating arrangement (there with reference sign 100) may also represent an embodiment of a heating device according to the present invention, insofar as the control housing of that application is formed from a plastics material.

In particular, the control housing (reference sign 30, FIGS. 1 and 4-7) of that application (DE'489) may correspond to the first module housing of the present description. The carrier body (reference sign 10) of that application (DE 10 2022 128 489) may correspond to the support plate of the present description. The control unit (reference sign 3) of that application may correspond to the control module of the present description. The control printed circuit board (reference sign 31) of that application (DE 10 2022 128 489) may correspond to the printed circuit board of the present description. The heat transfer side 11 and heating side 12 described in that application (DE 10 2022 128 489) (see FIGS. 1 to 6 of the priority application) in relation to the carrier body or the support plate are also shown in the present FIG. 1. The cover body described in that application (reference sign 17) may correspond to the deep-drawn base component 24 of the heat exchanger of the present description. Furthermore, in the above description of the exemplary embodiment, the punched grid 8 is indicated as a component with conductor tracks embedded in a common plastics component. In the priority application (DE 10 2022 128 489). In the priority application (DE 10 2022 128 489), it is described as a conductor track partially enclosed by a plastics insert, but the punched grids designate the same object with the same functions, as FIGS. 1, 2, 4 and 6-7 of the priority application (DE 10 2022 128 489) show.

### LIST OF REFERENCE SIGNS

1 electric heating device
11 heat transfer side
12 heating side
2 heat exchanger
21 fluid inlet
22 fluid outlet
24 base component, deep-drawn
25 cover component, plate-shaped and flat, support plate
26 fluid chamber
27 through-opening
28 fastening screws (for control module on support plate)
3 heat conversion unit
31 housing cover
32 attachment element
33 tab
34 heating elements
35 power switching component
36 heating conductor track
37 bond connection
38 temperature sensors
39 bond connection
4 control module
40 control device
401 printed circuit board
402 potting compound
407 positioning pins
41 first module housing
411 base component
412 cover
413 interior
414 opening for high-voltage connector portion
415 corrugation
417 lug
418 groove
419 pressure equalization opening
42 second module housing
43 aperture in first module housing
44 first layer of electrically conductive plastics material
441 holes in first layer
442 excluded portion in first layer
443 recess for metal ring in first layer
45 second layer of electrically insulating plastics material
491 Gore-tex membrane
492 seal (between control module and support plate)
493 reinforcement (module housing)
494 screw hole
5 heat transfer module
52 attachment area (for control module)
6 high-voltage connector portion
7 low-voltage connector portion
8 punched grid
81 connections for control device
83 connections for bond connection
85 dome-like positioning pins
9 sheet metal inserts
91 metal ring
92 first metal line
93 second metal line

1. An electric heating device for a vehicle, electric or hybrid vehicle, comprising
a heating device housing,
at least one heating element, which is configured for heating operation at an operating voltage in the high-volt range;
a heat exchanger which is in thermal operative connection with the at least one heating element in order to transfer the heat generated by the heating element to a medium flowing through the heat exchanger; and
a control module comprising a control device which is configured to supply the at least one heating element with the operating voltage in the high-volt range and to control the heating operation of the at least one heating element;
wherein the control module has a first module housing which is part of the heating device housing, is formed from a plastic and accommodates the control device therein.

2. The electric heating device as claimed in claim 1, wherein
the operating voltage in the high-volt range is 60 V or more.

3. The electric heating device as claimed in claim 1, wherein
the heat exchanger and the at least one heating element form a heat exchanger module and are accommodated in a second module housing; and
the first module housing is a different component from the second module housing.

4. The electric heating device as claimed in claim 1, wherein
the first module housing has a first layer of electrically conductive plastics material.

5. The electric heating device as claimed in claim 4, wherein
the electrically conductive plastics material is a plastic reinforced with carbon fibers.

6. The electric heating device as claimed in claim 5, wherein
the first module housing has a second layer of electrically insulating plastics material.

7. The electric heating device as claimed in claim 6, wherein
the electrically insulating plastics material is a plastic reinforced with glass fibers.

8. The electric heating device as claimed in claim 6, wherein
the second layer externally forms an exposed outer surface of the first module housing and the first layer internally surrounds an interior of the module housing relative to the second layer, wherein
the first layer and the second layer are molded together and form a one-piece component

9. The electric heating device as claimed in claim 4, wherein
a high-voltage connector portion is formed in the first module housing and is at least partially enclosed by a metal ring connected to a ground potential, wherein the metal ring is at least one of: embedded in the first layer of electrically conductive plastics material and between the first layer and the second layer, wherein the metal ring is formed from at least one of: aluminum, copper, and sheet steel.

10. The electric heating device as claimed in claim 9, wherein at least one of:
the metal ring is electrically conductively connected to a metal support plate (25) of the heat exchanger module via a first metal conductor embedded in the electrically conductive plastics material of the first layer, and
the metal ring is electrically conductively connected to a ground connection of a printed circuit board of the control device via a second metal line embedded in the electrically conductive plastics material of the first layer.

11. The electric heating device as claimed in claim 4, wherein
a low-voltage connector portion is formed in a portion of the first module housing, wherein the first layer of the electrically conductive plastics material does not extend in the portion, so that a wall of the first module housing in the region of this portion is formed substantially only by the second layer of the electrically insulating plastics material.

12. The electric heating device as claimed in claim 1, wherein
at least one aperture is formed in the first module housing for passing through an electrical connection between the control device in the first module housing and a power switching part for switching the heating element in the second module housing,
wherein a punched grid with conductor tracks embedded in a common plastics component is arranged in the at least one aperture, wherein the conductor tracks contact corresponding connection points on a printed circuit board forming the control device.

13. The electric heating device as claimed in claim 12, wherein
the punched grid extends through the aperture and the through-opening into an interior of the first module housing, where it is fixed to the printed circuit board forming the control device by at least one positioning means, wherein at least one of the at least one positioning means is a positioning pin.

14. The electric heating device as claimed in claim 12, wherein
fastening means, one or more screws, are provided in order to fasten a support plate of the heat exchanger module to the first module housing wherein the support plate has a through-opening which is aligned with the at least one aperture, so that the punched grid extends through the through-opening of the support plate and provides contact connections for the conductor tracks on the opposite side thereof,
wherein a seal is provided between facing surfaces of the first module housing and the support plate, which seal encloses the at least one through-opening or the aperture and thereby protects the interior of the first module housing and an interior of the second module housing accommodating the power switching part and the heating element from moisture ingress.
